(19) United States
(12) Patent Application Publication
(10) Pub. No.: US 2014/0373168 A1
(43) Pub. Date: Dec. 18, 2014

(54) METHOD OF PROTECTING PRIVACY DATA OF AN APPLICATION PROGRAM AND APPARATUS USING THE SAME

(71) Applicant: Tencent Technology (Shenzhen) Company Limited, Shenzhen (CN)

(72) Inventors: Yong Chen, Shenzhen (CN); Xeusheng Qi, Shenzhen (CN)

(21) Appl. No.: 14/471,745

(22) Filed: Aug. 28, 2014

Related U.S. Application Data
(63) Continuation of application No. PCT/CN2013/089971, filed on Dec. 19, 2013.

(30) Foreign Application Priority Data
Apr. 12, 2013 (CN) 201310127870.0

(51) Int. Cl. G06F 21/60; G06F 21/51; G06F 21/53; G06F 9/445

(52) U.S. Cl. CPC G06F 21/60; G06F 8/61; G06F 21/51; G06F 21/53
USPC 726/26

(57) ABSTRACT

The present application is applied to data processing technique field, providing an application program privacy data protection method and an apparatus. The method includes: creating a privacy space, including creating a user interface and a data storage area that the privacy space corresponds to, the user interface of the created privacy space is the same as the user interface of the normal space; when installing an application program, it is determined whether the application program has been installed into the normal space; if the result of the determination is yes, the application program is installed into the privacy space; if the result of the determination is no, the application program is installed in the privacy space and the normal space respectively. Through the present application, it is possible to protect the privacy data of the application program in the user terminal without any trail.

### CROSS REFERENCE TO RELATED APPLICATION

This application is a continuation of International Patent Application No. PCT/CN2013/089971, filed on Dec. 19, 2013, which claims priority to Chinese patent application No. 201310127870.0 filed in the SIPO on Apr. 12, 2013 with title of “METHOD OF PROTECTING PRIVACY DATA OF AN APPLICATION PROGRAM AND APPARATUS USING THE SAME”, the entire content of which is hereby incorporated by reference.

### TECHNICAL FIELD

The present application relates to data processing technique field, and particularly, to a method of protecting privacy data of an application program and an apparatus using the same.

### BACKGROUND ART

With the improvement of the processing capability of terminal devices (for example, smart cell phones, flat computers) and the development of information technique, the application programs (APP) implemented in the terminal device is increasing. Particularly, some application programs, for example social applications such as Wechat, Weibo (Micro-blog), MoMo and the like, own mass users and those users are high on communication with each other by using such social applications.

In using the applications, some privacy data may be produced in the user data of the application. The privacy data may be the data such as contacts information of contacts and chatting records and so on. Therefore, the issue of protecting privacy following the privacy data becomes more and more important. For example, in case that the cell phone is lost, or in case that the cell phone may be lent to other people, the screen of a cell phone can be seen by other people (such case often occurs), which could cause the leakage of the privacy data of the user of the application program in the cell phone.

Prior art provides a protection method of the user privacy data of the application program, as shown in FIG. 1. This method has the function to set password lock protection for an application program. If an application program is locked, that is, an access password is set, when the user access the locked application program, a password interface will pop up, as shown in the right of FIG. 1, the user can enter the application program only after inputting the right password in the password interface, and access the user data in the application program.

However, as shown in FIG. 1, prior art has the following backwards: The method directly restricts the right of the user to access an application program. Although other people can not obtain the privacy data of the application program at the first time, the method obviously suggests other people: “there is a secret in the application program, so it needs to using a password to access.” This obvious suggestion may cause a motivation of other people to decrypt the password, and the existing password decryption technique can easily be utilized to decrypt the password, therefore, cause the leakage of the user privacy data.

### SUMMARY OF INVENTION

In an aspect, the present application provides an application program privacy data protection method, which can completely protect the privacy data of the application program in the user terminal without being aware of the privacy data.

The method for protecting privacy data of an application program according to the present application is applied to a terminal device having a normal space which includes a corresponding user interface and data storage area. The method comprises: creating a privacy space, the created privacy space having a user interface and a data storage area and the user interface of the created privacy space is the same as the user interface of the said normal space; determining whether an application program has been installed into the normal space when installing the application program into the privacy space; installing the application program into the privacy space, storing related data of the application program into the data storage area of the privacy space and displaying an icon of the application program in the user interface of the privacy space if the application program has been installed into the normal space; or installing the application program in the privacy space and the normal space respectively, storing the related data of the application program into the respective data storage areas of the privacy space and the normal space and displaying an icon of the application program on the respective user interfaces of the privacy space and the normal space if the application program has not been installed into the normal space.

According to another aspect, an application program privacy data protection method is provided, which is applied to a terminal device having a normal space and a privacy space each of which has a user interface and a data storage area and the user interface of the privacy space being same as the user interface of the normal space. The method comprises: installing a same application program into the privacy space and the normal space respectively; storing related data of the installed application program into the respective data storage areas of the privacy space and the normal space respectively; and displaying an icon of the installed application program in the respective user interfaces of the privacy space and the normal space respectively.

According to still another aspect, the present application provides an application program privacy data protection apparatus being implemented in a terminal device having a normal space which includes a user interface and a data storage area. The apparatus comprises: a space creating unit configured to create a privacy space having a user interface and a data storage area, the user interface of the created privacy space being same as that of the normal space; a first determination unit configured to determine whether an application program has been installed into the normal space when an application program is to be installed; and an application program installation unit configured to, if the application program has been installed into the normal space, install the application program into the privacy space, store related data of the application program into the data storage area of the privacy space, and display an icon of the application program in the user interface of the privacy space if the application program has been installed into the normal space, or if the application program has not been installed into the normal space, install the application program in the privacy space and the normal space respectively, store the related data of the application program into the respective data storage areas of the privacy space and the normal space, and display an icon of the application program on the respective user interface of the privacy space and the user interface of the normal space.

According to still another aspect, the present application provides an application program privacy data protection apparatus being implemented in a terminal device having a normal space and a privacy space each of which having a user interface and a data storage area, the user interface of the privacy space being same as the user interface of the normal space are same. The application program privacy data protection apparatus comprises: an application program installation unit configured to install a same application program into the privacy space and the normal space respectively, storing related data of the installed application program into the respective data storage areas of the privacy space and the normal space respectively, and display an icon of the installed application program in the respective user interfaces of the privacy space and the normal space respectively.

Comparing to prior art, the embodiment of the present application has advantageous effects: the embodiment of the present application, when installing an application program, by creating privacy space, guarantees the application program has been installed into both the privacy space and the normal space, since the storage area of the related data of the installed application programs is different, the applications of the application programs in different spaces are independent, although the icons and functions and the like of application programs that can be seen in the user interface of different spaces are the same, the user data of the application programs are independent, that is, the data stored in a data storage area that a normal space corresponds to is the ordinary data (non-privacy data) of the application program, the data stored in a data storage area that a privacy space corresponds to is the privacy data of the application program, therefore, the privacy data of an application program can be protected effectively, the security of the privacy data can be improved. Moreover, because user interfaces of different spaces and application program icons and functions and the like displayed on the user interface are same, it is possible to make other people erroneously think there are no privacy data, and the privacy data of the application program in the user terminal can be protected without any trail. In addition, since the application programs are installed in different spaces respectively, different spaces correspond to different data storage area, therefore, when an application program in a space is upgraded or updated, it does not affect an application program in another space, and the data incompatibility caused by application program upgrading can be avoided effectively.

### BRIEF DESCRIPTION OF THE DRAWINGS

In order to describe the embodiments of the present application more clearly, a brief description on the drawings which are refereed to in describing the present disclosure will be made below. Apparently, the drawings described below are only some embodiments of the disclosure and other drawings can be conceived based on the described drawings by the person skilled in the art without paying any inventive effort.

FIG. 1 is a schematic diagram of an existing method for protecting privacy data of an application program.

FIG. 2 is a flowchart of implementing a method for protecting privacy data of an application program according to a first embodiment of the present application.

FIG. 3 is a flowchart of implementing a method for protecting privacy data of an application program according to a second embodiment of the present application;

FIG. 4 is a flowchart of implementing a method for protecting privacy data of an application program according to a third embodiment of the present application.

FIG. 5 is a flowchart of implementing a method for protecting privacy data of an application program according to a fourth embodiment of the present application.

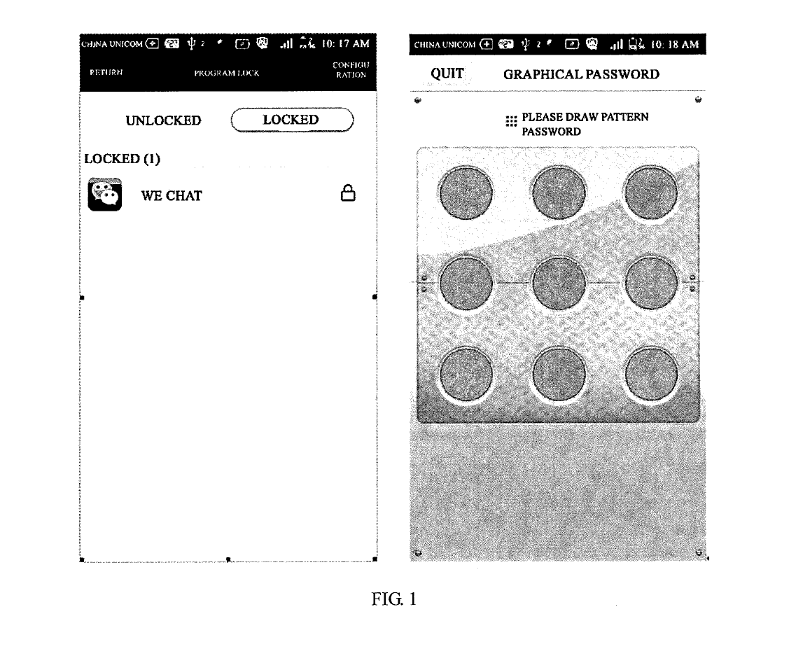

### DETAILED DESCRIPTION

In order to make the technical solution and advantages of the application more apparent, a more detailed description of the application will be given below in conjunction with the embodiment and the accompanying drawings. It should be understood that the embodiments described here are only construed to interpret the present application, not to restrict the application.

Next, the technical solution of the present application will be illustrated by specific embodiments.

### Embodiment 1

FIG. 2 is a flowchart of implementing a method for protecting privacy data of an application program according to a first embodiment of the present application. The method is implemented in a terminal device having a normal space. The normal space includes the corresponding user interface and data storage area. The method includes the flowing steps.

At first, at step S201, a privacy space is created. Specifically, a privacy space creation button or a privacy space creation instruction can be preset. After receiving a privacy space creation instruction issued by the user clicking the privacy space creation button, a terminal begins to create a privacy space. Creating such a privacy space includes creating identification, a user interface and a data storage area and so on that the privacy space corresponds to. At least one privacy space is created and application programs installed in each of privacy space may be the same or different from each other.

It should be noted that, in order to protect the privacy data of the application program in the user terminal under the condition that others are not aware of the privacy data, the user interfaces of the privacy space and the normal space created by the embodiment are the same. That is, all the layouts, styles and colors of the privacy space and the normal space are the same (the user interface of the privacy space can be created by the user based on the user interface of the normal space, or automatically created by the system based on the user interface of the normal space. That is, the data associated with the user interface of the user interface are copied into the data storage area of the privacy space and a main screen is newly created, and the copied related data are displayed on the main screen.) Meanwhile, in order to ensure the independence of the operation of the application program in different spaces, the data storage area assigned to privacy space is different from that of the normal space. For example, if the data storage area of the normal space is disc C, the data storage area of the privacy space is assigned to D disc.

In addition, after creating the privacy space, a space creation button or a space switching instruction (for example, slide to left or to right or the like) need to be set. After receiving the space switching instruction issued by the user clicking the space switch button, a terminal switches from the normal space to the privacy space or from the privacy space to the normal space.

During the operation of a terminal, the terminal device only corresponds to one space. That is, the terminal is in one working mode when operating and can be switched into other space according to a switching operation of the user. For example, a terminal device runs in a normal space by the default and the terminal can be switched from the normal space into the privacy space, and vice versa, the he terminal can be switched back from the privacy space into the normal space. To keep the privacy of the privacy space, when switching from the normal space to the privacy space, the authentication information need to be inputted. The switching from the normal space to the privacy space cannot be made until detecting input authentication information is the same as the preset authentication information. Specifically, when the user clicks the space switch button or issues a space switching instruction, the terminal firstly determines whether the current space is a normal space or a privacy space. If the current space is a normal space, it is detected whether the information identical to the authentication information is received. If the received information is the same as the predetermined authentication information, the terminal switches from the normal space to the privacy space. Otherwise, if the current space is a privacy space the terminal switches from the privacy space into the normal space directly.

The authentication information can be preset by the user and can be several digits, letters and/or gestures (for example, counterclockwise sliding or clockwise sliding on the screen).

At step S202, when installing an application program, it is determined whether an application program has been installed in the normal space. If the result of the determination is “yes”, the process proceeds to step S203. Otherwise, the process proceeds to step S204.

In this embodiment, it is able to determine whether an application program has been installed in the normal space by detecting whether the icon of the application program are displayed on the user interface of the normal space and/or the data storage area of the normal space has the application program.

At step S203, an application program is installed in the privacy space, the related data of the installed application program is stored in the data storage area of the privacy space, and the icon of the installed application program is displayed on the user interface of the privacy space. In this embodiment, displaying the icon of the application program on the user interface of the privacy space can be performed by user manual operation, that is, the icon of the application program can be manually added to the user interface of the privacy space, or the icon of the application program can be automatically added to the user interface of the privacy space by the system.

It should be noted that, when the application program has been installed in the normal space and the application program also needs to be installed in the privacy space, the installation path of the application program needs to be changed (that is, the installation path of the application program is changed to the storing path of the data storage area of the privacy space) and/or the name of the application program installation file needs to be changed, the related data of the installed application program is stored in the data storage area of the privacy space, and the icon of the installed the application program is displayed on the user interface of the privacy space.

At step S204, the application program is installed in the privacy space and normal space respectively, the related data of the installed application program is stored in the data storage area of the privacy space and the data storage area of the normal space respectively, and the icon of the installed the application program is displayed on the user interface of the privacy space and the user interface of the normal space respectively.

In this embodiment, in order to protect the privacy data of the application program in the user terminal under the condition that others cannot be aware of the privacy data, it is ensured that the non-user data (including kind, amount, icon of application programs) of any application program are the same in both the normal space and the privacy space. That is, it is ensured that the normal space and the privacy space have the same application programs installed therein. In this embodiment, before installing an application program, it is determined whether the application program has been installed into the normal space firstly. If the application program has been installed into the normal space, the application program will be installed into the normal space. Otherwise, the application program is installed into both the privacy space and the normal space respectively. That is, when an application program is installed into the privacy space, the related data of the installed application program are stored into the data storage area of the privacy space and the icon of the installed application program is displayed on the user interface of the privacy space. Similarly, when an application program is installed into the normal space, the related data of the installed application program are stored into the data storage area of the normal space and the icon of the installed application program is displayed on the user interface of the normal space. However, the installation order is not be limited to that mentioned above.

Preferably, when installing an application program into the privacy space specifically, it is needed to determine whether the application program is an application program to be protected or not in advance and then the application program is installed into the privacy space in case that t the application program is an application program to be protected.

As another preferred embodiment of the present application, in order to avoid there are too much application programs in the privacy space which wastes the storage space, the basic information of the installation can be set through an application program installation interface, the basic information includes a installation path, whether an application program is to be protected and so on. The terminal device determines whether an application program is an application program to be protected based on the basic information. If the result of the determination is yes, the application program is installed under the installation path associated with the privacy space and the normal space.

Preferably, in daily life, such situation often occurs, sometimes, the cell phone is left on a table and privacy space is forgot to be quitted. When other people pick up the cell phone, they could view the privacy data of the application program in the privacy space. To this end, this terminal device can automatically switch to the normal space when detecting the time during which the user did not operate (that is, the cell phone is in the waiting state) exceeds a preset value (for example, 1 minute). With this configuration, even though other people pick up the cell phone, they can view only the ordinary data because the cell phone has been switched into the normal space. Thus, the security of the privacy data is further improved.

Further, the terminal device can determine whether an application program is currently running in the privacy space when detecting the operation switching from the privacy space to the normal space. If an application program is currently running in the privacy space, the terminal device terminates the running of the application program in the privacy space and starts the same application program in the normal space. With this configuration, when the user is operating an application program in the privacy space, if other people want to view the user's cell phone screen, or hope to borrow his/her cell phone, the user can quickly switch the cell phone from the privacy space into the normal space, meanwhile, and start the application program being in the normal space same as the terminated application program in the privacy space. To do this, when other people view the cell phone screen, the application program in the normal space is running on cell phone screen in which the ordinary data of the application program are displayed and other people cannot view the privacy data of the application program. Accordingly, the purpose of “other people cannot be aware that I have the privacy data” is achieved, so that the motivation that other people want to decrypt the privacy data is avoided to improve the security of the privacy data.

When installing application program, this embodiment of the present application can guarantee that the application program is installed in both the normal space and the privacy space through the following operations: creating the privacy space, if the application program is installed in the normal space, then the application program is installed in the privacy space, if the application program is not installed in the normal space, then the application program is installed in the normal space and the privacy space respectively. Since the storage area of the related data of the installed application program is different, so the application of the application program in a different is independent, although icons and functions and the like of application programs seen in the user interface of different spaces are the same, the user data of the application programs are independent, that is, the data stored in the data storage area that the normal space corresponds to are the ordinary data (non-privacy data) of the application program, the data stored in a data storage area that the privacy space corresponds to are the privacy data of the application program, therefore, the privacy data of an application program can be protected effectively, the security of the privacy data can be improved. Moreover, because user interfaces of different spaces and application program icons and functions and the like displayed on the user interface are same, it is possible to make other people erroneously think there are no privacy data, and the privacy data of the application program in the user terminal can be protected without any trail. In addition, since the application programs are installed in different spaces respectively, different spaces correspond to different data storage area, therefore, when an application program in a space is upgraded or updated, it does not affect an application program in another space, and the data incompatibility caused by application program upgrading can be avoided effectively.

It shall be noted that, if there is only installed one application program in two spaces, different data storages are set in different spaces (for example, the non-privacy data are stored in the normal space, the privacy data are stored in the privacy space), if protecting the privacy data through data backup, space switch, when upgrade or update an application program in a space, easily cause the data in another space are not compatible with the data in the space, since the two spaces use the same application program, therefore, the application program in another space can not executes, and can not protect privacy data.

To better understand the embodiments of the present application, the above process will be illustrated by an example, it should be understood by those skilled in the art that the example is only used to explain the present application, and is not to limit the protection scope of the present application.

Creating a privacy space includes creating the user interface and the data storage area that the privacy space corresponds to. Wherein, the created user interface of the privacy space and the created user interface of the normal space are the same, the data storage area of the privacy space and the data storage area of the normal space are different.

The storage space assigned to the normal space is disc C, the storage space assigned to the privacy space is disc D. The application program waiting to be installed is the QQ. Before installing the QQ, first, it is determined whether the QQ has been installed in the normal space or not (that is, to determine whether there is a the QQ-related folder under disc C directory and/or a the QQ icon is displayed in the user interface of the normal space or not), if the result of the determination is yes, the QQ is installed disc also; otherwise, the QQ is installed disc C and disc respectively, and the icon of the installed QQ is displayed on the user interfaces that the normal space and the piracy space correspond to respectively. When the user startups the QQ in the normal space, that is, double-clicks the QQ icon on the user interface of the normal space, the corresponding data are read from disc C, when the user startups the QQ in the privacy space, that is double-clicks the QQ icon on the user interface of the privacy space, the corresponding data are read from D disc. Since disc C and disc D are independent each other, the QQ and its applications installed on disc C and the QQ and its applications installed on disc Dare also independent each other. If the user thinks today's chat content is important and do not want it to be seen by other people, he/she can enter the privacy space, and initiate the QQ in the privacy space to chat. In addition, when having detected that the user has quitted from the privacy space, if the QQ is till executing in the privacy space, the QQ executing in the privacy space is stopped, and the QQ in the normal space is initiated. Since the user interfaces of the normal space and the privacy space and the QQ icons and functions on the user interfaces are the same, therefore, other people will be led to misunderstand there are no privacy data, the privacy data of the application program in the user terminal can be protected without any trail. Moreover, since two QQ are installed in different discs respectively, when upgrading or updating the QQ in a space, the QQ in another space will not be affected, for example, the QQ version used in the normal space is Version 2013, the QQ version used in the privacy space is Version 2012.

### Embodiment 2

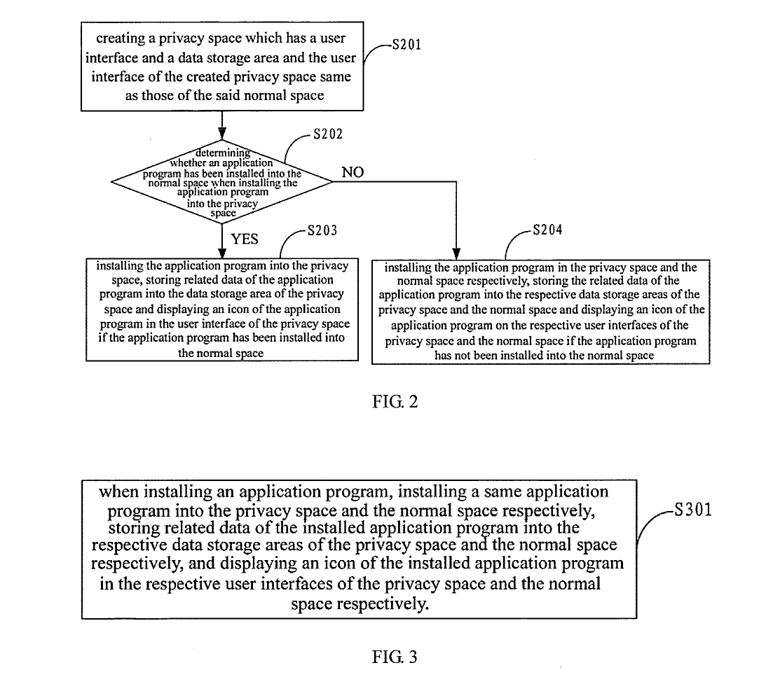

FIG. 3 is a flowchart of implementing a method for protecting privacy data of an application program according to a second embodiment of the present application. The application scenario of the method is applied to a terminal device having a normal space and privacy space. Both the normal space and privacy space include a user interface and a data storage area that the normal space and privacy space correspond to, wherein, the user interface of the privacy space and the user interface of the normal space are the same, the data storage area of the privacy space and the data storage area of the normal space are different, the detailed description of the process of it is given below:

At step S301, when installing an application program, the application program is installed in the privacy space and normal space respectively, the related data of the installed application program are stored into the data storage area of the privacy space and the data storage area of the normal space respectively, and the icon of the installed application program is displayed on the user interface of the privacy space and the user interface of the normal space respectively.

The difference between this embodiment and embodiment 1 is that the terminal device of this embodiment has created a normal space and a privacy space in advance. When the terminal device detects that the user is installing the application program, it automatically installs the application program in both the normal space and privacy space respectively so as to protect the privacy data of the application program in the user terminal without any trail. To do this, when installing the application program, installing the application program in the normal space and privacy space respectively ensures that icons displayed in the respective interfaces of the normal space and privacy space and functions thereof are the same. Further, with this configuration, the data incompatibility caused by application program upgrading can be avoided effectively. Other aspects of the embodiment and embodiment 1 are the same. Therefore, the description with respect to the other aspect of the embodiment is omitted for simplicity.

### Embodiment 3

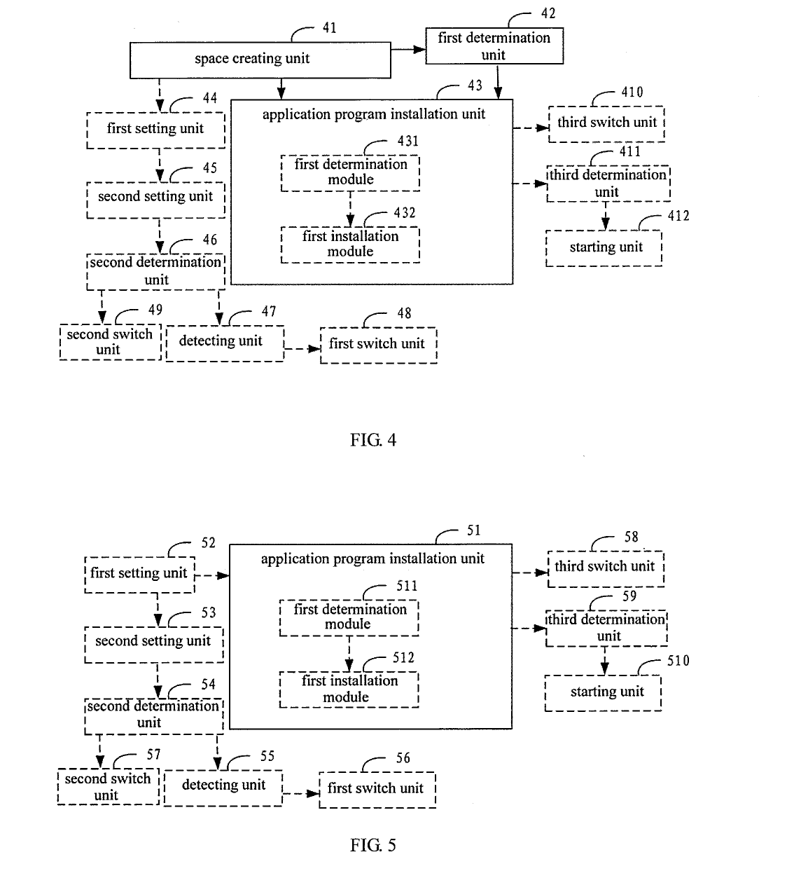

FIG. 4 is a flowchart of implementing a method for protecting privacy data of an application program according to a third embodiment of the present application. For the sake of illustration, only the part related with this embodiment of the present application is shown.

The application program privacy data protection apparatus is applied to a terminal device (for example, cell phone, flat computer, handheld computer, computer and the like) including a normal space, the normal space includes the corresponding user interface and data storage area.

The application program privacy data protection apparatus includes a space creation unit 41, a first determination unit 42, and an application program installation unit 43.

The space creating unit 41 is configured to create a privacy space having a user interface and a data storage area, the user interface of the created privacy space being same as that of the normal space and the data storage area of the created privacy space being different from the data storage area of the normal space.

The first determination unit 42 is configured to determine whether an application program has been installed into the normal space when an application program is to be installed.

The application program installation unit 43 is configured to, if the application program has been installed into the normal space, install the application program into the privacy space, store related data of the application program into the data storage area of the privacy space, and display an icon of the application program in the user interface of the privacy space if the application program has been installed into the normal space, or if the application program has not been installed into the normal space, install the application program in the privacy space and the normal space respectively, store the related data of the application program into the respective data storage areas of the privacy space and the normal space, and display an icon of the application program on the respective user interface of the privacy space and the user interface of the normal space.

Further, the application program installation unit 43 comprises a first determination module 431 configured to determine whether the application program is an application program to be protected and a first installation module 432 configured to install the application program into the privacy space if the application program is the application program to be protected.

Further, the application program privacy data protection apparatus further comprises a first setting unit 44 configured to set a switching mode between the normal space and the privacy space so that a switching operation between the normal space and the privacy space can be performed after the switching mode is triggered.

Further, the application program privacy data protection apparatus further comprises: a second setting unit 45 configured to set authentication information for entering into the privacy space; a second determination unit 46 configured to determining whether a current space is the normal space or the privacy space after the switching mode is triggered; a second switch unit 49 configured to switch from the privacy space into the normal space directly in case that the current space is the privacy space; a detecting unit 47 configured to determine whether information same as the authentication information is received in case that the current space is the normal space; and a first switch unit 49 configured to switch from the normal space into the privacy space in case that the information same as the authentication information is received.

Further, the application program privacy data protection apparatus further comprises a third switch unit 410 configured to switch the privacy space into the normal space in case that the current space is the privacy space and is not operated for a time exceeding a preset time.

Further, the application program privacy data protection apparatus further comprises: a third determination unit 411 configured to determine whether an application program is currently running in the privacy space before switching from the privacy space to the normal space; and an starting unit 412 configured to terminate the application program running in the privacy space and starting the application program in the normal space same as the terminated application program in the privacy space in case that the application program is currently running in the privacy space.

It should be understood by those skilled in the art that, for convenience and simplicity, the illustration is given by example just according to the division of the above function units and modules. In practical applications, the above function distribution may be carried by different function units and modules according the needs, that is, the internal construction of the apparatus is divided into different function units and modules to realize all or part of the above functions. All of the function units and modules in this embodiment may be integrated into one processing unit, or each unit exists independently in physics, or two or more unit are integrated into one processing unit. The above integrated units may be realized by hardware or software function units. In addition, the concrete names of each function units and modules are just used to distinguish them each other, not to restrict the protection scope of this application. For the concrete operating processes of above function units and modules, a reference to the corresponding processes of the above method embodiment 1 can be made, and the repeated description thereof is omitted.

### Embodiment 4

FIG. 5 is a flowchart of implementing a method for protecting privacy data of an application program according to a fourth embodiment of the present application. For the sake of illustration, only the part related with this embodiment of the present application is shown.

The application program privacy data protection apparatus is applied to a terminal device (for example, cell phone, flat computer, handheld computer, computer and the like) including a normal space and a privacy space, both the normal space and privacy space include the corresponding user interface and data storage area, wherein, the user interface of the privacy space and the user interface of the normal space are the same, the data storage area of the privacy space and the data storage area of the normal space are different.

The application program privacy data protection apparatus includes an application program installation unit 51 which is configured to install a same application program into the privacy space and the normal space respectively, storing related data of the installed application program into the respective data storage areas of the privacy space and the normal space respectively, and display an icon of the installed application program in the respective user interfaces of the privacy space and the normal space respectively.

An application program privacy data protection apparatus being implemented in a terminal device having a normal space and a privacy space each of which having a user interface and a data storage area, the user interface of the privacy space being same as the user interface of the normal space are same, and the application program privacy data protection apparatus comprising:

Furthermore, the application program installation unit 51 comprises a first determination module 511 configured to determine whether the application program is an application program to be protected and a first installation module 512 configured to install the application program into the privacy space if the application program is the application program to be protected.

Further, the application program privacy data protection apparatus further comprises a first setting unit 52 configured to set a switching mode between the normal space and the privacy space so that a switching operation between the normal space and the privacy space can be performed after the switching mode is triggered.

Further, the application program privacy data protection apparatus further comprises: a second setting unit 53 configured to set authentication information for entering into the privacy space; a second determination unit 54 configured to determining whether a current space is the normal space or the privacy space after the switching mode is triggered; a second switch unit 57 configured to switch from the privacy space into the normal space directly in case that the current space is the privacy space; a detecting unit 55 configured to determine whether information same as the authentication information is received in case that the current space is the normal space; and a first switch unit 56 configured to switch from the normal space into the privacy space in case that the information same as the authentication information is received.

Further, the application program privacy data protection apparatus further comprises a third switch unit 58 configured to switch the privacy space into the normal space in case that the current space is the privacy space and is not operated for a time exceeding a preset time.

Further, the application program privacy data protection apparatus further comprises: a third determination unit 59 configured to determine whether an application program is currently running in the privacy space before switching from the privacy space to the normal space; and an starting unit 510 configured to terminate the application program running in the privacy space and starting the application program in the normal space same as the terminated application program in the privacy space in case that the application program is currently running in the privacy space.

It should be understood by those skilled in the art that, for convenience and simplicity, the illustration is given by example just according to the division of the above function units and modules. In practical applications, the above function distribution may be carried by different function units and modules according the needs, that is, the internal construction of the apparatus is divided into different function units and modules to realize all or part of the above functions. All of the function units and modules in this embodiment may be integrated into one processing unit, or each unit exists independently in physics, or two or more units are integrated into one processing unit. The above integrated units may be realized by hardware or software function units. In addition, the concrete names of each function units and modules are just used to distinguish them each other, not to restrict the protection scope of this application. For the concrete operating processes of the above function units and modules, a reference to the corresponding processes of the above method embodiment 2 can be made, and the repeated description thereof is omitted.

It also should be understood by those skilled in the art that, all or part of the steps of the method of the above embodiment may be realized by the related hardware which is instructed by a program, the program may be stored in a computer readable storage medium, the storage medium includes a ROM/RAM, a magnetic disk, an optical disk or the like.

The above content is a further detailed specification taken in conjunction with the specific preferred embodiments of the present application, the present application should not be considered as limiting to those embodiments. It should be understood by those skilled in the art that equivalent substitutions or obvious modifications may occur without departing from the spirit of the present application, and all of the same performance or usage should not be considered belonging to the protection scope of the patent provided by the claims.

1. A method for protecting privacy data of an application program, comprising:
creating a privacy space, by a terminal comprising a processor, the created privacy space having a first user interface and a first data storage area, wherein the terminal comprises a normal space having a second user interface and a second data storage area, and wherein the first user interface is the same as the second user interface;
determining, by the terminal, whether the application program has been installed into the normal space;
installing the application program into the created privacy space, storing related data of the application program into the first data storage area and displaying an icon of the application program in the first user interface if the application program has been installed into the normal space; or installing the application program in the created privacy space and the normal space respectively, storing the related data of the application program into the first and second data storage areas and displaying an icon of the application program on the first and second user interfaces if the application program has not been installed into the normal space.

2. The method for protecting privacy data of an application program according to claim 1, the step of installing an application program into the created privacy space comprising:
determining whether the application program is an application program to be protected; and
installing the application program into the created privacy space if the application program is the application program to be protected.

3. The method for protecting privacy data of an application program according to claim 1, further comprising:
setting a switching mode between the normal space and the created privacy space so that a switching operation between the normal space and the created privacy space can be performed after the switching mode is triggered.

4. The method for protecting privacy data of an application program according to claim 3, further comprising setting authentication information for entering into the privacy space.

5. The method for protecting privacy data of an application program according to claim 3, wherein the step that a switching operation between the normal space and the created privacy space can be performed after the switching mode is triggered comprising:
determining whether a current space is the normal space or the created privacy space;
switching from the created privacy space into the normal space if the current space is the created privacy space; and
determining whether the authentication information is received if the current space is the normal space and switching from the normal space into the created privacy space if the authentication information is received.

6. The method for protecting privacy data of an application program according to claim 5, further comprising:
switching the created privacy space into the normal space if the current space is the created privacy space and is not operated for a time exceeding a preset time.

7. The method for protecting privacy data of an application program according to claim 6, further comprising:
determining whether an application program is currently running in the created privacy space; and
terminating the application program running in the created privacy space and starting the application program in the normal space if the application program is currently running in the created privacy space.

8. An application program privacy data protection method implemented on a terminal including a processor and a non-transitory memory the method applied to the terminal having a normal space and a privacy space, each of the normal space and the privacy space having a user interface and a data storage area and the user interface of the privacy space being the same as the user interface of the normal space, wherein the method comprises:
installing, by the terminal, the application program into the privacy space and the normal space respectively;
storing related data of the installed application program into the respective data storage areas of the privacy space and the normal space respectively; and
displaying an icon of the installed application program in the respective user interfaces of the privacy space and the normal space respectively.

9. An application program privacy data protection apparatus being implemented in a terminal having a normal space comprising a processor and having a first user interface and a first data storage area, the apparatus comprising:
a space creating unit, configured to create a privacy space having a second user interface and a second data storage area, the second user interface of the created privacy space being the same as the first user interface;
a first determination unit, configured to determine whether an application program has been installed into the normal space; and
an application program installation unit, configured to, if the application program has been installed into the normal space, install the application program into the privacy space, store related data of the application program into the second data storage area of the privacy space, and display an icon of the application program in the second user interface of the privacy space if the application program has been installed into the normal space, or if the application program has not been installed into the normal space, install the application program in the privacy space and the normal space respectively, store the related data of the application program into the first and second data storage areas, and display an icon of the application program on the first and second user interfaces.

10. The application program privacy data protection apparatus according to claim 9, the application program installation unit comprising:
a first determination module configured to determine whether the application program is an application program to be protected; and
a first installation module configured to install the application program into the privacy space if the application program is the application program to be protected.

11. The application program privacy data protection apparatus according to claim 9, further comprising:
a first setting unit configured to set a switching mode between the normal space and the privacy space so that a switching operation between the normal space and the privacy space can be performed after the switching mode is triggered.

12. The application program privacy data protection apparatus according to claim 11, further comprising:
a second setting unit configured to set authentication information for entering into the privacy space,
a second determination unit configured to determining whether a current space is the normal space or the privacy space after the switching mode is triggered;
a second switch unit configured to switch from the privacy space into the normal space directly if the current space is the privacy space; and
a detecting unit configured to determine whether information same as the authentication information is received if the current space is the normal space; and
a first switch unit configured to switch from the normal space into the privacy space if the authentication information is received.

13. The application program privacy data protection apparatus according to claim 9, further comprising:
a third switch unit configured to switch the privacy space into the normal space if the current space is the privacy space and is not operated for a time exceeding a preset time.

14. The application program privacy data protection apparatus according to claim 13, further comprising:
a third determination unit configured to determine whether an application program is currently running in the privacy space before switching from the privacy space to the normal space; and
an starting unit configured to terminate the application program running in the privacy space and start the application program in the normal space if the application program is currently running in the privacy space.
